(19) United States
(12) Patent Application Publication
(10) Pub. No.: US 2003/0115111 A1
(43) Pub. Date: Jun. 19, 2003

(54) Mediated order management agent

(76) Inventor: Douglas C. Fisher, Mountain View, CA (US)

Correspondence Address: HOWARD E LEBOWITZ, 905 WEST MIDDLEFIELD ROAD, NO. 971, MOUNTAIN VIEW, CA, 94043, US

(21) Appl. No.: 10/227,987

(22) Filed: Aug. 26, 2002

Related U.S. Application Data
(60) Provisional application No. 60/314,845, filed on Aug. 25, 2001.

(51) Int. Cl. G06F 17/60

(52) U.S. Cl. 705/26

(57) ABSTRACT

This invention pertains to a method, system, on-line service and software for on-line e-commerce. One preferred embodiment of the invention is a method, system, and on-line service, offered on a public network such as the Internet, for mediating a buyer's interaction with a first seller chosen by the buyer by observing when the buyer has indicated the intent to purchase an item at a first purchase price, seeking to obtain the item from alternative sellers at a lower price and obtaining one or more alternative bids, comparing the one or more alternative bids and the first purchase price according to pre-established rules, selecting a best offer, and completing the purchase of the best offer without further intervention of the buyer.

This application claims the benefit of Provisional Patent Application No. 60/314,845, entitled “Mediated order management agent” dated Aug. 25, 2001.

### BACKGROUND OF THE INVENTION

1. Field of the Invention

The field of the invention is e-commerce over a public network such as the Internet and particularly purchasing merchandise or services using network enabled devices.

2. Description of the Prior Art

Electronic commerce and the Internet have enabled millions of consumers and businesses worldwide to buy and sell goods more cost effectively than traditionally possible. Electronic advertising, product catalogs and order processing systems have produced significant improvements, though these mechanisms have been limited by the static nature of their pricing models.

Over the past few years, static pricing has effectively become the de facto standard for retail purchases on the Internet. Static pricing refers to a sales environment where goods and/or services are offered catalogue style, where particular items are offered at a price and terms (or possibly price as a function of terms). Static prices are typically slow to adapt to market conditions, therefore a gap develops between the asking price and the fair market value. However, an advantage of the static pricing—catalogue style of business is that it is familiar and convenient to consumers.

The growth of Dynamic Commerce is expected to significantly enhance buyers and sellers ability to conduct commerce on the Internet.

Dynamic Commerce is defined as buying of goods in an environment where prices and terms (e.g. delivery-time, seller reputation, payment, etc.) are free to move in response to supply and demand conditions in the time frame of a purchase decision and execution. Dynamic Commerce has at its core the ability to optimize purchase price for both buyer and seller. Unlike traditional sales approaches that involve pre-established, fixed prices, Dynamic Commerce involves fluid bidding approaches similar to those used in financial trading exchanges. Dynamic pricing allows buyers and sellers to track and update the status of their bids, obtain information on the amount of time remaining for bidding, etc.

While Dynamic Commerce is being implemented in many fashions, there are three distinct types of implementation models that have been built on the “English auction” model, in which supply and demand are regulated by buyers and sellers:

1. Auctions—are designed to obtain the best price for a seller's merchandise through competitive bidding (e.g. ubid.com)

2. Reverse auctions—are very similar in concept. A buyer(s) seek the lowest price for goods by creating competition among sellers to respond to the buyers stated needs (e.g. Priceline)

3. Exchanges—are “many to many” markets which bring together multiple buyers and sellers in an attempt for all parties to achieve maximum value by continually refining market prices (e.g. eBay, VerticalNet)

Note that ‘Negotiation’ between a buyer and a seller is not included as a Dynamic Commerce model because negotiation does not aggregate buyer and seller demand. Traditionally, negotiations between two parties involve repeated communications in an attempt to reach a mutually acceptable arrangement.

The most successful implementation model for Dynamic Commerce has been eBay's exchange which brings together millions of buyers and sellers. Satisfying the needs of a single buyer or seller through Dynamic Commerce has proven more difficult.

For example, the reverse auction model has been unsuccessful for low to medium cost goods. The largest companies in this area, Mercata, Priceline and MobShop have all experienced difficulties implementing the model. Mercata and Mobshop both shut down their services. Priceline shut down their groceries and gasoline purchasing service, though they have been successful with their higher priced airline ticket purchasing service.

These companies operated as a group-buying service for consumers. Market analysts believe these companies experienced difficulties because:

1. They were unable to obtain a critical mass of buyers and sellers. Without the ability to aggregate buyers into large groups, sellers could not reduce prices sufficiently.

2. They required the consumer to wait sometimes for days to receive discounted prices. Michael May of Jupiter/MediaMetrix, said Mercata's foray “was inherently flawed” because it prevented shoppers from buying on impulse.

3: Consumers were required to do too much extra work to buy goods. According to research firm, The Gartner Group, Priceline's flaw is its belief that consumers will tolerate a low-convenience purchasing experience in exchange for cost savings.

4. Customers were not willing to put up with the uncertainty where they put in a bid and did not know whether a seller was going to be found to fill the bid.

5. Consumers disliked not knowing who the seller would be until after the transaction was confirmed.

Another disadvantage of competitive markets is that when consumers utilize them they forgo the benefits of buying from a known seller. Consumers purchasing on the Internet have had a choice, either utilize a known retailer or attempt to get a better deal through a competitive market service.

U.S. Pat. No. 5,794,207 to Walker, et al, discloses a type of reverse auction wherein a buyer enters with central controller a conditional purchase offer “CPO” that is capable of being accepted if the conditions are met by a seller. The controller submits the CPO to potential sellers and completes a sale when a potential seller agrees to the terms. The controller qualifies the buyer (authentication and credit) and seller (ability to supply the goods) so that a contract may be quickly and automatically formed when a match is made. Walker's invention allows an on-line buyer to realize the benefits of competition, but denies the buyer the convenience of being able to shop for exactly what merchandise is desired. Also, the process is really not a true auction, because the buyer must make a binding offer to buy at the beginning of the process. Buyers are unlikely to do this without specifying a price, thus a buyer is really asking a seller to meet the buyer's price rather than asking sellers to compete for the business by offering their lowest price.

U.S. Pat. No. 5,960,411 to Hartman, et al, discloses a very convenient “one click” method for concluding an order for an identified item in an e-commerce transaction. This method allows a very convenient method for consumers to make their choice of merchandise and immediately and securely finalize their order, however it does not provide for direct competition for the buyer's business.

U.S. Pat. No. 6,101,484 to Halbert, et al, discloses a system for allowing e-commerce consumers to realize the benefits of mass purchasing by forming buyers' cooperatives. This method and system provides an incentive for sellers to provide advantageous competitive prices, but does not offer the benefits of convenience and selection which are offered by individual e-commerce merchants.

There is a need for an improved e-commerce environment which provides a purchasing environment wherein a consumer can have the convenience of single merchant purchasing while in the same transaction realizing the benefits of a competitive auction for the business.

There is a need for an e-commerce environment that provides a consumer with the convenience of one-click purchases across a plurality of merchants.

There is a need for an e-commerce environment that provides a consumer with a convenient purchasing environment while realizing the benefits of a competitive auction for the business while protecting the buyer's identity from merchants.

### SUMMARY OF THE INVENTION

The invention, Mediated Order Management Agent “MOMA” is a new paradigm for electronic commerce, an electronic agent that allows buyers to dynamically shift trading methods to best take advantage of known and unknown sellers. While MOMA's objective is to maximize value for the buyer, MOMA also provides a cost-effective way for sellers to communicate and negotiate with buyers. One preferred embodiment of MOMA is a method, system, and on-line service offered on a public network such as the Internet, for mediating a buyer's interaction with a first seller chosen by the buyer by observing when the buyer has indicated the intent to purchase an item at a first purchase price, seeking to obtain the item from alternative sellers at a lower price and obtaining one or more alternative bids, comparing the one or more alternative bids and the first purchase price according to pre-established rules, selecting a best offer, and completing the purchase of the best offer without further intervention of the buyer. This embodiment requires the MOMA service to obtain the pre-established rules for selecting the best offer in advance, as well as the buyer's financial information which is required to complete the purchase. While the selection has been described in terms of price, the pre-established rules allow a buyer to have the bids compared based on a variety of criteria, such as transportation cost, distance or time, reputation of the seller, or the like, in addition to price. Also, the service will preferably establish a relationship with many potential sellers including establishing a protocol for transmitting inquiries and bids, and information on the types of goods and services which various sellers provide. In this embodiment the buyer's shopping experience follows the familiar static model, while providing the benefits of a highly competitive behind the scenes shopping process carried out by MOMA. In an alternative embodiment the purchase is not completed by MOMA, but alternative offers are presented to the buyer for selection prior to completion of the purchase, and the purchase order is completed after the selection is received from the buyer.

A system for implementing the service comprises the following components:

1. An agent component for monitoring purchasing transactions between each of a plurality of buyers with an on-line merchant, intercepting actions by each of said plurality of buyers that indicate an intention to purchase at least one item from an on-line merchant, intercepting information relating to said at least one item, presenting communications from the system to each of said plurality of buyers, and completing purchase forms to complete a purchase with a seller.

2. A portal component including a front end component for providing a world wide web interface to the plurality of buyers and at least one system operator, and a back-end component for exercising logic to interpret and process information relating to each of said at least one item, communicating with a market place means to request, receive, and interpret alternative bids corresponding to each of said at least one item.

3. An e-marketplace component for enrolling alternative sellers and obtaining alternative bids for said at least one item chosen by a buyer.

4. A data store for storing data comprising buyer financial data and preferences, and merchant data and preferences.

5. A protocol for communications between the e-marketplace means and alternative sellers and among the e-marketplace means and the portal means.

In one embodiment of the invention the agent component of the system comprises software embedded in the web portal of the MOMA service, that becomes activated when the buyer logs in. In an alternative embodiment the agent component comprises an application executing on a buyer's computer. In a third embodiment the agent is embedded into the portal and acts on a buyer's behalf, such that a buyer sees the portal web presentation and an on-line merchant page as an integrated frames web page.

Another aspect of the invention is an on-line service available on a public network such as the Internet for provide the methods as provided above.

Still another aspect of the invention comprises instructions for carrying out the methods and system components described above in computer readable form such as a CD ROM or hard disk or the like.

It is an object of the invention to provide an improved e-commerce environment which provides a purchasing environment wherein a consumer can have the convenience of single merchant purchasing while in the same transaction realizing the benefits of a competitive auction for the business.

It is a further object of the invention to provide an e-commerce environment that provides a consumer with the convenience of one-click purchases across a plurality of merchants.

It is a still further object of the invention to provide an e-commerce environment that provides a consumer with a convenient purchasing environment while realizing the benefits of a competitive auction for the business while protecting the buyer's identity from merchants.

### BRIEF DESCRIPTION OF THE DRAWINGS

These and other features, aspects and advantages of the present invention will become better understood with regard to the following description, appended claims and accompanying drawings, where:

FIG. 1 is a flow diagram showing the embedded agent MOMA system architecture.

FIG. 2 is a diagram showing the MOMA Portal Internal Components.

FIG. 3 is a flow diagram showing the E-Marketplace message flow.

FIG. 4 is a flow diagram of the agent assisted MOMA system architecture

FIG. 5 is a flow diagram showing the Mediated MOMA system architecture.

### DESCRIPTION

Overview of the Business Method

Mediated Order Management Agent (MOMA) is a new form of electronic commerce, an electronic agent that allows buyers to dynamically shift trading methods to best take advantage of known and unknown sellers. While MOMA's objective is to maximize value for the buyer, MOMA also provides a cost-effective way for sellers to communicate and negotiate with buyers. One preferred embodiment of MOMA is a method, system and on-line service for mediating a buyer's interaction with a first seller conducted over a public network, observing when the buyer has selected an item for purchase at a first purchase price, seeking to obtain the item from alternative sellers at a lower price and obtaining one or more alternative offers, comparing the one or more alternative offers and the first purchase price according to pre-established rules, selecting a best offer, and completing the purchase of the best offer without further intervention of the buyer. In this embodiment the buyer's shopping experience follows the familiar static model, while obtaining the benefits of a highly competitive behind the scenes shopping process carried out by MOMA. In an alternative embodiment the purchase is not completed by MOMA, but the alternative offers are presented to the buyer for selection prior to completion of the purchase

A buyer who has registered with MOMA, can shop at any merchants site. Registration preferably includes registering the buyer's financial information, such as credit card or checking account information to be used for purchases, and priority rules for choosing a preferred bid. Once the desired goods are found, the buyer signs onto MOMA and clicks on the desired goods/price and then allows MOMA to source for a better deal from other sellers. A MOMA transaction is thus initiated by a buyer indicating purchasing intent at a known seller. Intent is indicated by the buyer taking an action such as highlighting or clicking on the desired good on a merchants web site, or any other location where the action can be mediated by MOMA (for example, a buyer equipped with a PDA with a bar code scanner can indicate interest by scanning a books bar code while in a physical book store, and identify the merchant. Based on the buyers preferences, MOMA would locate a better deal for the book and will either automatically purchase the book or present its results to the buyer and establish a negotiation channel between the customer and the default merchant, who might state “10% off if you buy the book in the next ten minutes” and with the other sellers).

It should be appreciated that while the method has been described in terms of purchase of a single item in a transaction the method could equally be applied to choosing a group of items or an electronic shopping basket of items for which bids could be obtained item by item or alternatively as a group.

The adoption of MOMA, will result in buyers considering a wider range of sellers in a particular product category, more competitive pricing by sellers, an increase in specialist sellers who have no need to advertise/market their goods and therefore can sell more cheaply, and deeper relationships between those buyers and sellers who continue to do business together.

MOMA provides a flexible approach for the default merchant and other sellers to compete for the buyers business. In the table below, merchant participation options are described along the top of the table in increasing complexity. Buyer preference settings are described along the left side in increasing complexity:

| | | Standing | Marketplace |
|---|---|---|---|
| | No Participation | Agreement | Participation |
| One click = on | Simplified buying as | N/A | N/A |
| Agent = off | there is no need to | | |
| | pass through | | |
| | merchants | | |
| | confirmation screens | | |
| One click = on | MOMA determines if | MOMA checks its | MOMA publishes |
| Agent = on | other sellers can | database for any | buyers need to |
| Confirm = on | provide a better deal, | negotiated discounts | marketplace, sellers |
| | if so, confirm choice | previously arranged | submit best offer |
| | with buyer | with sellers | |
| One click = on | Same as confirm = on, | Same as confirm = on, | Same as confirm = on, |
| Agent = on | except MOMA | except MOMA | except MOMA |
| Confirm = off | chooses seller and | chooses seller and | chooses seller and |
| | completes purchase | completes purchase | completes purchase |

MOMA supports one-click purchases across merchants. Referring to the above table, when Agent=on (with Agent=on, MOMA is instructed to search for alternative options) and confirm=off (with confirm=off, MOMA completes the purchase of the selected item with the best seller).

MOMA preferably also provides the default seller the opportunity to negotiate with MOMA, either by establishing a standing discount agreement or by accessing the ‘marketplace’.

MOMA preferably provides a range of mechanisms whereby other sellers can participate in MOMA's service as listed below:

1. Standard discount agreements. For example, one bookseller may establish a standard deal with MOMA whereby they will charge 10% less on all books when a particular competitor is the default merchant.

2. Static catalog. Sellers specify discounted price at the product level

3. Real time marketplace. Sellers provide the best price for a customer at the current time

4. Web crawlers. A MOMA will preferably search the web for the best deals, or access other 3^{rd} party services that search the web (e.g. Dealtime)

Other Preferred Features

Automatic evaluation of potential sellers. To address the difficulty a buyer would have in reviewing and evaluating many sellers, the invention comprises a rules based system for selecting sellers which uses buyers preferences as an input, maintains a reputation rating for sellers, etc. For example, a buyer might specify that the lowest price seller be selected, while another buyer may want to remain with the default seller unless the product can be found 20% cheaper elsewhere.

Optional anonymity for buyers and sellers. There are a number of circumstances where keeping identities private will result in the best market price being found. In addition, buyers and sellers may only want their identity revealed once a buyer has selected a sellers offer.

Both buyers and sellers can specify preferences. For example, seller preferences would include customers desired geographic location, pay by cash, etc.

Dynamically varying purchasing process based on buyer and seller preferences. Adapt to different situations and different types of purchased goods.

Summary of Benefits of the Business Method

MOMA may provide to other merchants, a product description, the default merchant's price, buyer demographics and history database in order to maximize the chances of obtaining a better bid.

MOMA innovation is its light weight technology and flexible integration options that allow sellers to join easily. Buyer receives one-click simplified purchase across many sellers.

Real time processing with no significant delay in locating sellers. Buyer doesn't have to wonder whether the order will be met as he already found the product. The process has the feel of buying at a favored e-commerce site to the buyer.

Introduces, competitive mechanism as an automated extra to traditional purchasing methods.

MOMA gives consumers greater buying power due to improved market information and increased competition (automation).

Negotiation is not normally supported on web sites. MOMA web service allows merchants to improve deal to consumer rather than risk losing the sale to other sellers. MOMA provides a negotiation channel between the merchant and consumer.

MOMA provides a way to dynamically alter the price based on buyers real time needs. It does this by identifying the buyer, attesting to the order and specifying the goods that they require.

Buyer can shop at the most convenient/user friendly sites yet receive an assurance that the terms are competitive without doing extra work

A number of trends has recently made the invention more desirable. These include the fact that the Internet has reduced the cost of implementing coordination mechanisms between buyers and sellers. Product identity is becoming standardized, such as by industry standard bar code identifications. Finally, Internet agents have been widely introduced.

Technical Description of the Preferred Embodiments

Introduction to MOMA and MOMAS

MOMA is an invention of a software system that offers online buyers the combined convenience and benefits of universal one-click purchase with just-in-time check for best bargains. In this description the invention will be described in terms of the Internet, however it should be understood that the invention could be implemented on other public networks and the Internet is used simply as an example.

Central to MOMA is intermediated online purchasing. Using a standard Web browser from any Internet-enabled device, the buyer browses merchandise from any e-commerce site from the MOMA portal. When the buyer clicks on items to begin purchase transaction, the MOMA agent embedded on the browser page senses the action through interpreting the current page content, contacts the MOMA marketplace for better bargains for the selected item, and informs the buyer when they are found. MOMA enables the merchants (including the default merchant) to negotiate with the buyer through the maintenance of a persistent two-way communication channel. Section 4 describes this interception process in greater details.

A distinguishing feature of MOMA is compatibility with existing merchant software. MOMAS works with existing Web interfaces to communicate with the merchant, requiring no software upgrade at the merchant site, unless the merchant chooses to support negotiation and register as seller in the MOMA marketplace as described below in the section entitled Process Workflow.

The technical design is described as s MOMA implementation in the form of a Web service, an online service that supports open standard programming interfaces, to be named MOMAS. The description will be clear to one skilled in the art of Internet technologies.

System Architecture

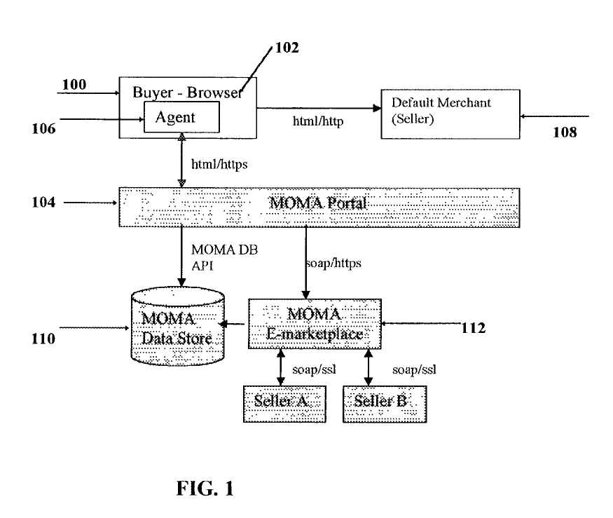

FIG. 1 depicts a general flow of how buyer interacts with MOMA (gray-out components) and all other parties involved, with the arrows indicating the initiation direction. The arrow between the buyer agent 106 and the MOMA Portal 104 indicates high level of trust via strong user authentication and protected communication channel. MOMA in this architecture can be considered a pure Web-based implementation.

Referring to FIG. 1, using a standard Web browser 102, the buyer 100 authenticates with MOMA Portal 104. The buyer then connects to any Internet merchant web site 108 from the portal page with the URL entry box (part of the Agent). Every buyer request and corresponding response from the merchant site is now mediated by the Portal.

This architecture is suitable for thin-client environments such as WAP (Wireless Access Protocol) phones and wireless-enabled PDAs (Personal Digital Assistants).

The server-side components, namely the Portal, Data Store and e-Marketplace, need to satisfy Internet-scale scalability and performance requirements. Since these modules are based on existing software system platforms, these platforms directly address those requirements in corresponding areas of application server, database, and server-side scripting. These platforms, in turn, typically rely on exploiting proven techniques of load balancing and clustering.

Not showing in FIG. 1 are the firewalls that exist within the system. Both the MOMA Data Store 110 and Marketplace 112 will reside behind service operator's firewall at certain secure locations as appropriate for their indicated functions. From access standpoint, the security policy needs to allow the Portal to connect to Marketplace, and for the latter to connect to MOMA Data Store.

Communication between the system components are protected by SSL (Secure Sockets Layer) and PKI (Public Key Infrastructure) based authentication as appropriate.

System Components

MOMAS is comprised of four principal MOMA components: Agent 106, Portal 104, Data Store 110 and E-Marketplace 112.

In a preferred embodiment, the agent is embedded into the PDP Portal, such that it can become active once the buyer signs on with the portal. Alternative embodiments will be presented where the portal is a separate client software executing on the buyer's computer and where it is a frame of an integrated web page. The agent provides the functionality in purchase order interception, price check initiation, and best offers presentation, as well as maintaining a trusted bilateral negotiation channel. It will be appreciated by those skilled in the art that since the agent is part of a Web page, there is no need to manage software version upgrades for the agent outside what's already supported in the standard Web browser today.

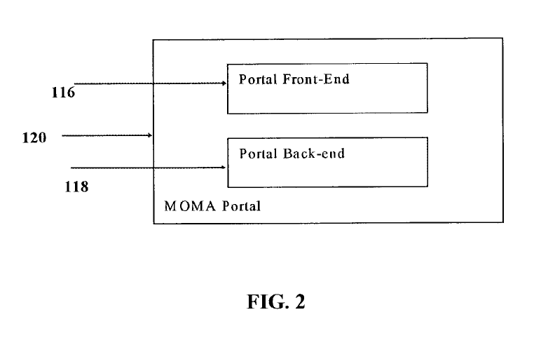

The Portal component is defined to be comprised of two primary sub-components: buyer-facing Web front-end 116 and application back-end 118, shown on FIG. 2. The front-end part typically runs in a Web server; the back-end-end part, in an application server.

The front-end part provides the browser-based management console for both buyers and MOMA system operators (SO). It provides a Web interface, for example HTML/XML/Javascript, accessible through a standard Web browser. The buyers use the Portal to change his MOMA buyer preferences. The SO's use it to effect system or buyer account-wise changes via the system preferences table.

The back-end part implements the screening business logic to intercept purchase forms and to process them accordingly. This part also maintains connection to the E-Marketplace for competitive bids on buyer's order request.

The Portal component runs as a server-side application of a HTTP server, preferably with support for Sun Microsystems' enterprise Java environment. All connections to the service daemon are preferably SSL-enabled.

The Portal is accessed by two categories of MOMA users, buyers and system operators. Buyers authenticates with the portal to modify buyer preferences, whereas the system operator modifies the system preferences. The Portal is also where the system operator performs system monitoring and management, e.g. Portal usage statistics for reporting purposes.

The Portal presents a Web buyer interface, namely a mix of HTML and JavaScript, accessible through a Web browser on a PC. In addition, a special WAP compatible version of the pages is preferably made available in a MOMA implementation so wireless or other Internet-enabled devices can access the Portal.

The MOMA Data Store is the data vault for buyer's data, including server-side e-wallet, personas, preferences, and security credentials/references. The Data Store can be partitioned into separate component databases, e.g. one for e-wallet and another for security settings. This way allows different security policy to be attached to each database, as well as making the system more scaleable.

The open MOMA DB API allows external data sources to be incorporated into the data store.

E-Marketplace is a highly competitive online market formed by participating merchants. By default the MOMA system operator acts in the role of market broker, responsible for managing the marketplace.

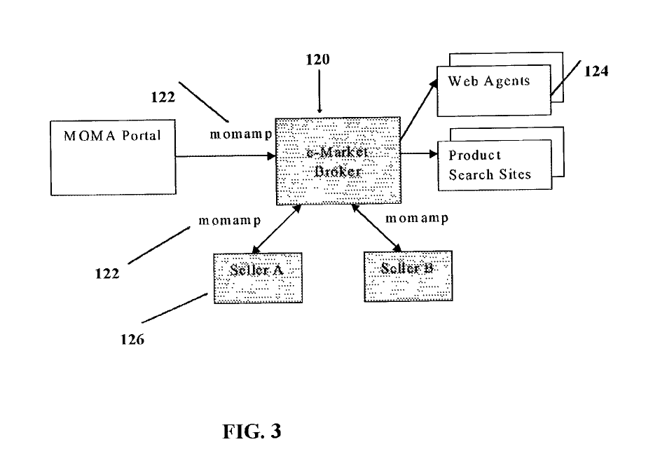

The E-Marketplace is shown in FIG. 3 comprising an e-Market broker 120 sub-component that can interface with external marketplaces, purchasing agents 124 and a plurality of sellers 126. The broker communicates with the sellers, agents, and the MOMA portal using a protocol 122.

The E-Marketplace operation contains a directory of registered MOMA merchants. The registration information mandatory for each merchant includes products and services offered, along with other selling attributes such as type of credit cards accepted. The data table for the directory is described below.

The merchants interact with the e-Marketplace through a publish and subscribe paradigm. Each merchant registers its interests with the marketplace. Orders that match these pre-registered interests would be forwarded immediately to the merchant. The merchant must act on the order within a predefined time window. All the competing offers sent by the competing merchants are then processed by the marketplace broker. The broker then presents to the buyer the offers in priority based on buyer preferences. Transaction history of each registered merchant is used to compute a reputation indicator.

Process Workflow

With MOMA mediation, the purchase process for the buyer can be automated for any merchant Web site. Since MOMA stores all of buyer's payment information, it can fill the recognized purchase forms automatically when buyer single clicks on “Buy” button.

Since MOMA interfaces with standard Web sites, this user convenience is extended to any Web merchant.

Detailed blueprints for filling in the merchant forms are stored in MOMA portal database. The agent retrieves these blueprints based on merchant's URL, and fill the forms with buyer's stored customer data.

The MOMA Portal monitors in real-time all traffic from buyer to merchant by analyzing the request URL or HTTP headers of the page contents, or selectively the page contents directly. Best heuristic approaches, e.g. keystroke interpretation, are used given the diverse nature of e-commerce forms/processes in existence, to be augmented by a knowledge database at the MOMA portal describing individual site differences from the normal conventions. There are certain pages that the portal is interested in, e.g. purchase order. Whenever such page is detected in transit, the portal invokes application logic that is designed to process it. For example, a comparison-shopping module can be invoked for a product purchase in transit to look for better price and terms of service. This shopping module has link to the e-Marketplace to present the order for competitive bidding.

Purchase Order Format

Each purchase order is described by the following attributes:

| Name | Type | Description |
|---|---|---|
| ProductID | Character | The unique product identification |
| | | number, e.g. ISBN for books. |
| Price | Currency | The offer price for the product by |
| | | default merchant. |
| Quantity | Numeric | The quantity ordered. |
| Product Description | Character | Product description |
| Shipping Address | Character | The postal address for item delivery. |
| MerchantID | Character | The default merchant identifier. |
| Warehouse Location | Character | Where the product will ship from. |
| Shipping Charges | Currency | Shipping charges based on shipping |
| | | method selected. |
| Target Shipping Date | Date | When the product is scheduled to |
| | | ship. |
| Delivery Service | Character | Type of delivery method selected. |
| Offer Date | Date | The date that all offers must be |
| | | received. |
| Other | . . . | . . . |

MerchantID can be the URL of the merchant's site. Merchants can always tell whether the outstanding purchase order has them as the default seller.

Each merchant in the e-Marketplace can bid on the outstanding orders based on these stated characteristics. The merchants in attempt to improve their offers can append additional attributes to their competing offers such as discount coupons on future purchases.

Optional Anonymous Transactions

MOMA can support transactions with anonymous buyers and sellers. The true identities of the parties can be hidden such that only MOMA the trusted intermediary has full knowledge of. MOMA given this knowledge can authenticate all parties before the transactions occur. MOMA maintains a pseudo-ID table, which maps to the real table.

MOMA Messaging Protocol (MOMAMP)

MOMA E-Marketplace components are gray-out in FIG. 3.

MOMAMP is a SOAP-based protocol, preferably over https, used by the Portal, e-Market Broker, and Merchant components to communicate with one another. The Broker is responsible for taking the purchase orders and presents them to the qualified merchants for competitive bids. Qualified merchants are among those registered with the system that satisfy the minimum buyer preferences as specified in the order such as warehouse location and shipping options.

MOMA sellers are required to support MOMA protocol, in order to participate in the e-Marketplace. However, the Broker has built-in support to connect to other Web agents or other commerce sites to conduct product and price searches.

Buyer Authentication Example

The Agent authenticates with the Portal via the following type of message:

POST /AuthTransaction HTTP/1.1
Host: www.MOMA-portal.com
Content-Type: text/xml; charset=“utf-8”
Content-Length: nnnn
SOAPAction:“http://schemas.exotrust.com/MOMA/AuthenticateBuyer/”
<SOAP-ENV:Envelope

xmlns:SOAP-ENV=“http://schemas.xmlsoap.org/soap/envelope/”
SOAP-ENV:encodingStyle=“http://schemas.xmlsoap.org/soap/encoding/”>

<SOAP-ENV:Body>

<m:AuthenticateBuyer

xmlns:m=“http://schemas.exotrust.com/MOMA/authorization/”>

<UserID>4A4A7660-CCE6-4629-A5DC-6D868F775DD2</UserID>

<UserName>MOMA_Buyer_John</UserName>
<EncrypteMOMAPassword> . . . </EncrypeMOMAPassword>
</m:AuthenticateUser>

</SOAP-ENV:Body>

</SOAP-ENV : Envelope>

The following message shows a sample success response:
HTTP/1.1 200 OK
Content-Type: text/xml; charset=“utf-8”
Content-Length: nnnn
<SOAP-ENV:Envelope
xmlns:SOAP-ENV=“http://schemas.xmlsoap.org/soap/envelope/”
SOAP-ENV:encodingStyle=“http://schemas.xmlsoap.org/soap/encoding/”/>

<SOAP-ENV:Body>

<m:AuthentcateUserResponse xmlns:m=“

http://schemas.exotrust.com/MOMAs/authentication”>

<m:AuthenticationStatus>OK, User logged in.</m:AuthenticationStatus>

</m:AuthenticateUserResponse>

</SOAP-ENV:Body>

</SOAP-ENV:Envelope>
Purchase Order Example
The following XML represents a typical order request in MOMA:
POST /PurchaseOrder HTTP/1.1
Host: www.MOMA-portal.com
Content-Type: text/xml; charset=“utf-8”
Content-Length: nnnn
SOAPAction: “http://schemas.exotrust.com/MOMA/PurchaseOrder/”
<SOAP-ENV:Envelope

xmlns:SOAP-ENV=“http://schemas.xmlsoap.org/soap/envelope/”
SOAP-ENV:encodingStyle=“http://schemas.xmlsoap.org/soap/encoding/”>

<SOAP-ENV:Body>

<m:OrderRequest
xmlns:m=“http://schemas.exotrust.com/MOMA/purchaseorder”>
<m:ItemIn quantity=“250” requestedDeliveryDate=“2001-03-29”>

<m:ItemID>

<m:SupplierPart>1234-CAT-DESIGN</m:SupplierPart>

</m:ItemID>
<m:ItemDetail>

<m:UnitPrice>

<m:Money currency=“CAN”>200.00</m:Money>

</m:UnitPrice>

</m:ItemDetail>
<m:ShipTo>

<m:Address>
<m:Name>Carleton Management Consulting</m:Name>
<m:PostalAddress name=“Management Consulting”>
<m:Street>1125 Colone By Drive</m:Street>
<m:City>Ottawa</m:City>
<m:PostalCode>K1S 5B6</m:PostalCode>

<m:Country>Canada</m:Country>

</m:PostalAddress>
</m:Address>

</m:ShipTo>
<m:Shipping>

. . .

</m:Shipping>

</m:ItemIn>

. . .

</m:OrderRequest>

</SOAP-ENV:Body>
</SOAP-ENV:Envelope>

MOMA Data Store

Data Store API

Since the data is stored in relational database, the data store interface is any SQL (Structured Query Language) compliant programming interface, preferably. JDBC, Java Database Connectivity API, which can be obtained on the Java website (http://java.sun.com), and is hereby incorporated herein by reference. Other non-SQL database can be supported through 3^{rd} party software that provides appropriate SQL wrappers.

There are two basic data tables: buyer preferences and system preferences, preferred versions of which are given below.

### Buyer Profile

| Field | Data Type | Comments |
|---|---|---|
| User Name | Character | Buyer's common name |
| User ID | GUID | Buyer's globally unique identifier |
| Authentication Method | Character | One of the following: |
| | | User-password |
| | | Digital certificate |
| User Password | Character | User's current encrypted password |
| User Digital Key | Character | Reference to Buyer's public PKI |
| Credential | | credential. |
| Email | Character | Buyer's email address |
| Phone | Digits | Buyer's contact phone number |
| Address | Character | Buyer's home address |
| Connection Status | Numeric | Indicates whether buyer is online |
| | | 0 YES |
| | | 1 NO |
| Purchase Reputation | Numeric | Buyer's historic purchase reputation |
| | | score. |
| Other | . . . | . . . |

Rule-Based Buyer and Seller Preferences

Each buyer and seller has their own preference table for specifying purchase or merchandising behavior. The e-Market Broker interprets these rules on behalf of buyers and sellers.

The following table lists the standard binary comparison operators:

| Operator | Meaning | Comments |
|---|---|---|
| > | Greater than | |
| < | Less than | |
| == | Equals | |
| ≧ | Greater than or equal to | |
| ≦ | Less than or equal to | |
| != | Not equal | |
| Other | . . . | . . . |

These operate on data fields as defined in Section 4.1.

The Rules Table is a set of records with each record contains simple statements formed by these comparisons. Compound statement is formed by applying AND or OR logic operator to a set of simple statements. Parenthesis can be used for grouping and setting order precedence.

For examples,

(1) Simple Statement on seller side

Price==xxxxxx AND Quantity [symbol] 10

(2) Compound Statement on seller side

(Shipping Address==CA) AND (Price==xxxxxx AND Quantity [symbol] 10)

(3) Compound Statement on buyer side

(Reputation==xxx) AND (Warehouse Location==CA)

The Rules Table has the following format:

| Rule Instance Name | Comparison | Action |
|---|---|---|
| Rule0 | <statement> | <action> |
| Rule1 | <statement> | <action> |
| . . . More . . . | | |

Actions are name-value pairs stored in the action table. The following table illustrates typical actions for buyer:

| Action Name | Action Value | Comments |
|---|---|---|
| Buy Confirm | YES/NO | Specify need for confirmation. |
| Free Shipping | YES/NO | Prefer free shipping |
| Shipping Date | Date | Specify latest shipping date. |
| . . . More . . . | . . . | . . . |

The following table illustrates typical actions for seller:

| Action Name | Action Value | Comments |
|---|---|---|
| Offer Discount | X % | Offer Discount, e.g. 10% |
| Offer Free Shipping | Yes/No | |
| Offer Gift Certificate | Certificate Reference | Offer gift certificate for |
| | | future purchases |

Similar to comparison statements, logical AND and OR operators apply to actions. For example:

Offer Discount=TRUE AND Offer Free Shipping=TRUE

System Settings

| Field Name | Field Value | Comments |
|---|---|---|
| User ID | <value of user id> | Buyer's unique identifier |
| Account Status | Enabled/disabled | Buyer account status, e.g. |
| | | password reset required. |
| Transaction Limit | <numeric value> | Buyer's allowed transaction |
| | | amount limit |
| . . . Other . . . | . . . | . . . |

The system operators manage these settings to administer buyer accounts.

Merchant Directory

The merchant directory for MOMA is a private UDDI, Universal Description, Discovery and Integration, registry. UDDI is an open industry standard for describing and discovering Web services such as MOMA. Details of an existing public UDDI registry can be found at http://www.uddi.org/, including the specifications thereof, white papers, and technical notes, which are hereby incorporated herein by reference.

The dynamic part of the directory is maintained by MOMA to store historic data on quality and reliability of seller's service.

Preferred Third Party Software Packages

1. Application server with support for Enterprise Java Beans (EJB),—BEA Systems' WebLogic Server

2. RDBMS—Oracle 8i

3. E-Marketplace application software—Commerce One Auction Services

Alternative Architectures

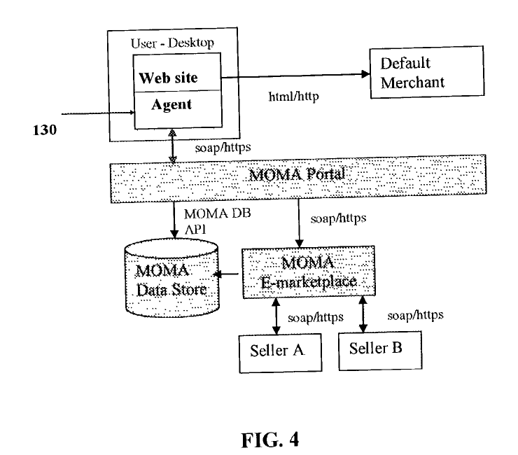

FIG. 4 depicts a scenario where the buyer is assisted by a desktop client agent 30 for making online purchases. In this case the desktop agent monitors the Web pages as the buyer shops and intercepts the request in which buyer decides to buy. The product information captured through this process is transmitted by the agent to the MOMA Portal and then to the E-marketplace.

The agent opens and maintains a second trusted channel, with merchant's being the first, to the Portal. The second channel can be established over a wired-line or wireless communication network, independently from how the first channel gets established.

The merchant is the default seller whose offer is compared to all others received in the e-marketplace. The competing offers are ordered and presented to buyer based on pre-stored buyer preferences.

The sections below describe in greater details the MOMA components and their interactions within their context.

The agent is a small client application that performs the monitoring of Web pages, looking for specific ones that trigger MOMA handling. The agent runs independently from the browser application.

The Agent functionality can be embedded into 3^{rd} party e-wallet programs, without requiring presence of the Agent. In this case, the e-wallet program must be modified to support the MOMAMP protocol. In this case, the MOMA-enabled e-wallet program establishes a secure link with MOMA portal for presenting the best offers.

The merchant sites may to follow the ECML (Electronic Commerce Modeling Language) which is a set of guidelines for online merchants to automate purchases initiated from digital wallets. See ftp://ftp.normos.org/ietf/internet-drafts/draft-ietf-trade-ecml2-spec-03.txt. for Guidelines, which are hereby incorporated herein by reference, to facilitate working with e-wallet software.

Purchase Process Interception

The agent constantly monitors the buyer purchase process by interpreting the changing content on the browser page, by examining the fields on a HTML form, as how client-side e-wallet works. That is typically done via application programming interfaces provided by the operating system, e.g. Win32 APIs. When the buyer initiates a purchase, the agent detects this and initiates MOMA processing as previously described.

Mediated MOMA System Architecture

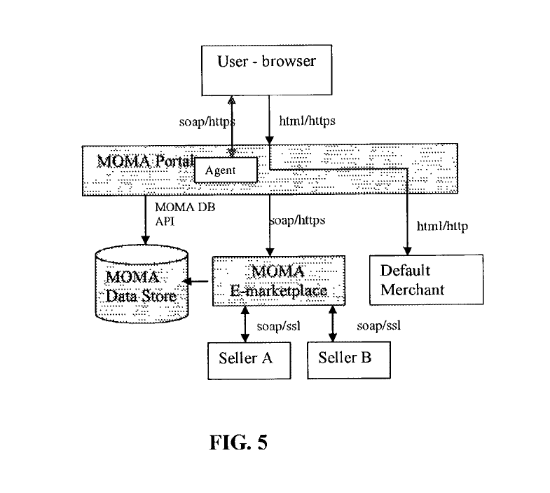

In FIG. 5, the agent is embedded into the Portal acting on buyer's behalf. The buyer sees the default merchant and MOMA portal as an integrated frames Web site from a standard browser. Behind the back MOMA Portal performs the Web site integration whereby pages are aggregated for end-user presentation and URLs within are re-routed for business logic processing.

The mediated architecture is particularly suitable for display/operating environment where a single page view has been the norm, such as wireless handhelds or Web-enabled mobile phones. This architecture is a natural fit for implementing centralized billing or any service aggregation in general.

Although the present invention has been described in considerable detail with reference to certain preferred versions thereof, other versions are possible. Therefore the spirit and scope of the appended claims should not be limited to the preferred versions herein.

What is claimed is:

1. A method of conducting efficient e-commerce transactions comprising the following acts conducted by an on-line service on a public network:
a) monitoring a buyer's interactions with a first seller until the buyer takes a first action, said first action indicating the buyer's intent to purchase at least one item from the first seller at a first price;
b) capturing the identity of the at least one item and the first price;
c) obtaining at least one alternative bid for the item; and
d) concluding a sale of the at least one item to the buyer.

2. The method of claim 1 further comprising the act of presenting the at least one alternative bid to the buyer prior to concluding the sale of the item to the buyer and receiving from the buyer a selection of a preferred choice.

3. The method of claim 2 wherein the preferred choice is offered by a second seller and wherein the act of concluding a sale comprises the acts of generating a purchase order between the buyer and the second seller for the at least one item and paying the second seller.

4. The method of claim 2 wherein the preferred choice is offered by the first seller and wherein the act of concluding a sale comprises the acts of generating an order between the buyer and the first seller for the at least one item and paying the first seller.

5. The method of claim 3 or claim 4 wherein the at least one alternative bid comprises a plurality of alternative bids.

6. The method of claim 5 wherein the at least one item comprises a plurality of items.

7. The method of claim 1, further comprising the following acts conducted prior to concluding the sale of the item to the buyer:
a) comparing the at least one bid to the first price; and
b) selecting a preferred choice from the group consisting of the at least one alternative bid and the first seller at the first price.

8. The method of claim 7 wherein the preferred choice is offered by a second seller.

9. The method of claim 7 wherein the preferred choice is offered by the first seller at the first price.

10. The method of claim 7 wherein the preferred choice is offered by the first seller at a second price, said second price being lower than said first price.

11. The method of claim 8 wherein the act of selecting a preferred choice is based on preferences which are obtained from the buyer prior to the buyer's interaction with the first seller.

12. The method of claim 11 further comprising obtaining payment instructions from the buyer prior to the buyer's interaction with the first seller.

13. The method of claim 12 wherein the act of concluding a sale follows without the need for any action by the buyer beyond said first action.

14. The method of claim 13 wherein the act of concluding a sale comprises the acts of generating an order between the buyer and the second seller for the at least one item and paying the seller in accordance with the payment instructions which are obtained from the buyer prior to the buyer's interaction with the first seller.

15. The method of claim 14 wherein the buyer's interaction with the first seller is an interaction that takes place between the buyer's network capable device and a site operated by the first seller on the public network.

16. The method of claim 14 wherein the buyer's interaction with the first seller is in person and the monitoring the buyer's interactions takes place in an interaction between the buyer and the on-line service over a mobile network capable device.

17. The method of claim 15 wherein the public network is the Internet and the site operated by the first seller is a World Wide Web e-commerce site and the network capable device is a computer.

18. The method of claim 16 wherein the mobile network capable device is chosen from the group consisting of mobile telephones and personal digital assistants.

19. The method of claim 9 or claim 10 wherein the act of selecting a preferred choice is based on preferences which are obtained from the buyer prior to the buyer's interaction with the first seller.

20. The method of claim 19 further comprising obtaining payment instructions from the buyer prior to the buyer's interaction with the first seller.

21. The method of claim 20 wherein the act of concluding a sale follows without the need for any action by the buyer beyond said first action.

22. The method of claim 21 wherein the act of concluding a sale comprises the acts of generating an order between the buyer and the first seller for the at least one item and paying the seller in accordance with the payment instructions which are obtained from the buyer prior to the buyer's interaction with the first seller.

23. A system for conducting efficient e-commerce transactions on a public network comprising:
a) at least one computer server comprising software executing thereon comprising the following functionality:
i) agent functionality for monitoring purchasing transactions between each of a plurality of buyers with an on-line merchant, intercepting actions by each of said plurality of buyers that indicate an intention to purchase at least one item from an on-line merchant, intercepting information relating to said at least one item, presenting communications from the system to each of said plurality of buyers, and completing purchase forms to complete a purchase with a seller;
ii) portal functionality comprising a front end which provides a world wide web interface to the plurality of buyers and at least one system operator, and a back-end which exercises logic to interpret and process information relating to each of said at least one item, communicate with a market place functionality to request, receive, and interpret alternative bids corresponding to each of said at least one item; and
iii) e-marketplace functionality for enrolling alternative sellers and obtaining alternative bids for said at least one item chosen by a buyer;
b) a data store, including the ability to store data comprising buyer financial data and preferences, merchant data and preferences; and
c) a protocol for communication between the e-marketplace functionality and alternative sellers and among the e-marketplace functionality and the portal functionality.

24. The system of claim 23 wherein the agent functionality is embedded in the portal functionality.

25. The system of claim 23 wherein the data store comprises a plurality of databases.

26. The system of claim 25 wherein the public network is the Internet.

27. A system for conducting efficient e-commerce transactions on a public network comprising:
a) agent means for monitoring purchasing transactions between each of a plurality of buyers with an on-line merchant, intercepting actions by each of said plurality of buyers that indicate an intention to purchase at least one item from an on-line merchant, intercepting information relating to said at least one item, presenting communications from the system to each of said plurality of buyers, and completing purchase forms to complete a purchase with a seller;
b) portal means comprising a front end means for providing a world wide web interface to the plurality of buyers and at least one system operator, and a back-end means for exercising logic to interpret and process information relating to each of said at least one item, communicating with a market place means to request, receive, and interpret alternative bids corresponding to each of said at least one item; and
c) e-marketplace means for enrolling alternative sellers and obtaining alternative bids for said at least one item chosen by a buyer;
d) data store means for storing data comprising buyer financial data and preferences, and merchant data and preferences; and
e) protocol means for communications between the e-marketplace means and alternative sellers and among the e-marketplace means and the portal means.

28. The system of claim 27 wherein the agent means comprises software functionality embedded in the portal web interface that becomes activated for a buyer when the buyer logs into the portal.

29. The system of claim 27 wherein the agent means comprises a client application operating on a buyer's computer.

30. The system of claim 27 wherein the agent means comprises software functionality embedded into an e-wallet program.

31. The system of claim 27 wherein the agent means is embedded into the portal and acts on a buyer's behalf, such that a buyer sees the portal web presentation and an on-line merchant page as at least two frames.

32. The system of claim 27 wherein the system contains functionality to allow access when the plurality of buyers are using network capable devices chosen from the group consisting of desktop computer systems, portable computers, wireless handheld computers, web enabled mobile telephones and personal digital assistants.

33. The system of claim 27 wherein the public network is the Internet.

34. An on-line service accessible to network enabled devices on a public network comprising the following functionality:
a) functionality for monitoring a buyer's interaction with an on-line merchant and detect an action indicative of the buyer's intent to buy an item at a first price;
b) functionality for obtaining additional bids for the item; and
c) functionality for completing a purchase of the item between the buyer and a seller.

35. The on line service of claim 34 further comprising functionality for choosing a preferred bid according to preferences specified by the buyer before the buyer's interaction with the on-line merchant, whereby the purchase of the item is completed without further action by the buyer.

36. The on-line service of claim 35 further comprising functionality for presenting a choice of bids to the buyer, and allowing the buyer to make a selection, whereby the purchase is completed in accordance with the selection.
